(19) United States
(12) Patent Application Publication
(10) Pub. No.: US 2021/0239801 A1
(43) Pub. Date: Aug. 5, 2021

(54) LASER-RANGING DEVICE AND MOBILE APPARATUS

(71) Applicant: SZ DJI TECHNOLOGY CO., LTD., Shenzhen (CN)

(72) Inventors: Xiang LIU, Shenzhen (CN); Huai HUANG, Shenzhen (CN); Xiaoping HONG, Shenzhen (CN)

(21) Appl. No.: 17/214,777

(22) Filed: Mar. 26, 2021

Related U.S. Application Data
(63) Continuation of application No. PCT/CN2018/108451, filed on Sep. 28, 2018.

(51) Int. Cl. G01S 7/481

(52) U.S. Cl. CPC G01S 7/4812; G01S 17/93; G01S 7/4816; G01S 7/4814

(57) ABSTRACT

A laser-ranging device includes an emitter, an optical assembly, a detecter, and a drive system. The emitter is configured to emit a laser pulse sequence. The an optical assembly includes a collimating lens and a converging lens. The collimating lens is configured to collimate the laser pulse sequence emitted by the emitter and emit the laser pulse sequence. The converging lens is configured to converge at least a part of return light reflected by a to-be-detected object. The detecter is configured to receive light converged by the converging lens, convert the light into an electrical signal, and determine a distance between the to-be-detected object and the laser-ranging device according to the electrical signal. The drive system is configured to drive the optical assembly to move in a plane perpendicular to an optical axis of the laser pulse sequence and/or along an optical axis direction of the optical axis.

### CROSS-REFERENCE TO RELATED APPLICATION

This application is a continuation of International Application No. PCT/CN2018/108451, filed Sep. 28, 2018, the entire content of which is incorporated herein by reference.

### TECHNICAL FIELD

The present disclosure generally relates to the optical detection field and, more particularly, to a laser-ranging device and a mobile apparatus.

### BACKGROUND

A ranging device plays an important role in many fields. For example, the ranging device can be applied at a mobile carrier or non-mobile carrier and configured to perform remote sensing, obstacle avoidance, surveying and mapping, modeling, environmental perception, etc. Especially, a mobile carrier, for example, a robot, a manned aircraft, an unmanned aerial vehicle (UAV), a vehicle, or a ship, may perform navigation in a complex environment by using the ranging device to realize path planning, obstacle detection, and obstacle avoidance. Miniaturization of the ranging device is discussed and researched. A laser-ranging module with a small volume can be conveniently used for flight at a determined height and obstacle avoidance of the UAV. However, the laser-ranging module with a small volume is usually limited by its detection distance and detection range and cannot be used in many application scenes.

### SUMMARY

Embodiments of the present disclosure provide a laser-ranging device including an emitter, an optical assembly, a detecter, and a drive system. The emitter is configured to emit a laser pulse sequence. The an optical assembly includes a collimating lens and a converging lens. The collimating lens is located on an emitting light path of the emitter and configured to collimate the laser pulse sequence emitted by the emitter and emit the laser pulse sequence out of the laser-ranging device. The converging lens is configured to converge at least a part of return light reflected by a to-be-detected object. The detecter is configured to receive light converged by the converging lens and convert the light into an electrical signal and determine a distance between the to-be-detected object and the laser-ranging device according to the electrical signal. The drive system is configured to drive the optical assembly to move in a plane perpendicular to an optical axis of the laser pulse sequence and/or along an optical axis direction of the optical axis.

Embodiments of the present disclosure provide a mobile apparatus including a focus adjustable imaging system and a laser-ranging device. The focus adjustable imaging system is configured to determine direction information of a target object relative to the imaging system according to a position of the target object in an image captured by the imaging system. The laser-ranging device is configured to adjust a detection direction of the laser-ranging device according to the direction information and detect a distance between the target object and the laser-ranging device. The laser-ranging device includes an emitter and an optical assembly. The emitter is configured to emit a laser pulse sequence. The optical assembly includes a collimating lens and a converging lens. The collimating lens is located on an emitting light path of the emitter and configured to collimate the laser pulse sequence emitted by the emitter and emit the laser pulse sequence out of the laser-ranging device. The converging lens is configured to converge at least a part of return light reflected by the target object.

### BRIEF DESCRIPTION OF THE DRAWINGS

FIG. 1 is a schematic architecture diagram of a laser-ranging device according to some embodiments of the present disclosure.

FIG. 2 is a schematic diagram showing a part of the laser-ranging device according to some embodiments of the present disclosure.

FIG. 3 is a schematic block diagram of the laser-ranging device according to some embodiments of the present disclosure.

FIG. 4 is a schematic diagram showing a principle of a time extraction method according to some embodiments of the present disclosure.

FIG. 5 is a schematic block diagram showing a laser-ranging device according to some other embodiments of the present disclosure.

### DETAILED DESCRIPTION OF THE EMBODIMENTS

To make purposes, technical solutions, and advantages of the present disclosure clearer, the technical solutions in embodiments of the present disclosure are described in conjunction with accompanying drawings in embodiments of the present disclosure. The described embodiments are only some embodiments not all the embodiments of the present disclosure. Based on the embodiments of the disclosure, all other embodiments obtained by those of ordinary skill in the art without any creative work are within the scope of the present disclosure.

In the following description, a lot of specific details are given to provide a more thorough understanding of the present disclosure. However, for those skilled in the art, the present disclosure can be implemented without one or more of these details. In some other examples, to avoid confusion with the present disclosure, some technical features known in the art are not described.

The present disclosure can be implemented in different forms and should not be considered as being limited to embodiments presented of the present disclosure.

The terms used here are only intended to describe specific embodiments and not to limit the present disclosure. When used here, singular forms of “a,” “an,” and “the/said” are also intended to include plural forms, unless otherwise specified in the context. Moreover, when being used in this specification, the terms “comprise” and/or “include” indicate the existence of the described features, integers, steps, operations, elements, and/or components, but do not exclude the existence or addition of one or more other features, integers, steps, operations, elements, components, and/or groups. When being used herein, the term “and/or” includes any and all combinations of related listed items.

For a better understanding of the present disclosure, a detailed structure is described in the following to explain the technical solutions provided by the present disclosure. Embodiments of the present disclosure are described in detail as follows. However, in addition to the detailed description, the present disclosure may also include other embodiments.

To solve the problem in the existing technology, the present disclosure provides a laser-ranging device. The laser-ranging device includes an emitter, an optical assembly including collimating lens and converging lens, a detecter, and a drive system. The emitter may be configured to emit a laser pulse sequence to detect a to-be-detected object. The collimating lens may be located in an emitting optical path of the emitter and configured to collimate the laser pulse sequence emitted by the emitter and then emit the collimated laser pulse sequence out of the laser-ranging device. The converging lens may be configured to converge at least a part of the light reflected by the to-be-detected object. The detecter may be configured to receive the light converged by the converging lens and convert the light into an electrical signal and, according to the electrical signal, determine a distance between the to-be-detected object and the laser-ranging device. The drive system may be configured to drive the optical assembly to move along in a plane perpendicular to an optical axis of the laser pulse sequence and/or along an optical axis direction.

In the laser-ranging device of the present disclosure, the drive system may be configured to drive the optical assembly including the collimating lens and the converging lens to move in the plane perpendicular to the optical axis of the laser pulse sequence to change a detection direction of the laser-ranging device. As such, distance information of to-be-detected objects that are nearby and far away may be obtained in a short time. The drive system may be further configured to drive the optical assembly including the collimating lens and the converging lens to move along the optical axis direction to change a field of view (FOV) of the laser-ranging device. As such, the detection distance of the laser-ranging device may be near or far. The detection direction may be changeable to improve the detection range of the laser-ranging device to improve detection efficiency. The structure of the laser-ranging device of the present disclosure may be a single point ranging structure. Thus, the structure is more compact and more miniaturized. Moreover, the lens is sufficiently used to reduce cost.

The laser-ranging device of the present disclosure is described in detail in connection with the accompanying drawings. When there is no conflict, features of embodiments and implementations may be combined with each other.

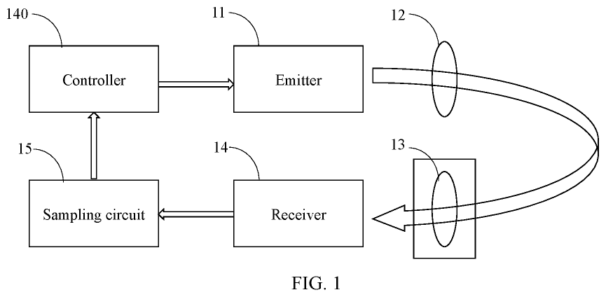

FIG. 1 is a schematic architecture diagram of a laser-ranging device according to some embodiments of the present disclosure. As shown in FIG. 1, the laser-ranging device includes an emitter 11. The emitter 11 may be configured to emit a laser pulse sequence to detect a to-be-detected object. The emitter 11 includes a laser emitter, a switch device, and a driver. The laser emitter may include a diode, for example, a positive-intrinsic-negative (PIN) laser diode. The laser emitter may emit the laser pulse sequence of a specific wavelength. The laser emitter may be referred to as a light source or light-emitting source.

The switch device is a switch device of the laser emitter, which may be connected to the laser emitter. The switch device may be configured to control the laser emitter to turn on or off. When the laser emitter is on, the laser emitter may emit the laser pulse sequence. When the laser emitter is off, the laser emitter may not emit the laser pulse sequence. The driver may be connected to the switch device to drive the switch device.

In some embodiments, the switch device may include a metal-oxide-semiconductor (MOS) field-effect transistor (FET). The driver may include a MOS driver. The MOS driver may be configured to drive the MOSFET used as a switch element. The MOSFET may control the laser emitter to turn on or off.

In some embodiments, the switch device may include a gallium nitride (GaN) transistor, and the driver may be a GaN driver.

In some embodiments, the laser-ranging device further includes a controller 140. The controller 140 may be configured to transmit a drive signal to the driver of the emitter to cause the driver to control at least one of control parameters, such as emitting power, a wavelength of emitted laser, or an emission direction, of the laser emitter according to the received drive signal.

As shown in FIG. 1, the laser-ranging device further includes an optical assembly. The optical assembly includes a collimating lens 12 and a converging lens 13. The collimating lens 12 is located at an emitting optical path of the emitter 11. The collimating lens 12 may be configured to collimate the laser pulse sequence emitted by the emitter 11 and emit the collimated laser pulse sequence from the laser-ranging device. When collimating the laser pulse sequence emitted by the emitter 11, the collimating lens 12 may reduce a divergence angle of the emitted laser pulse sequence to improve the precision of the ranging. The converging lens 13 may be configured to converge at least a part of the light reflected by the to-be-detected object.

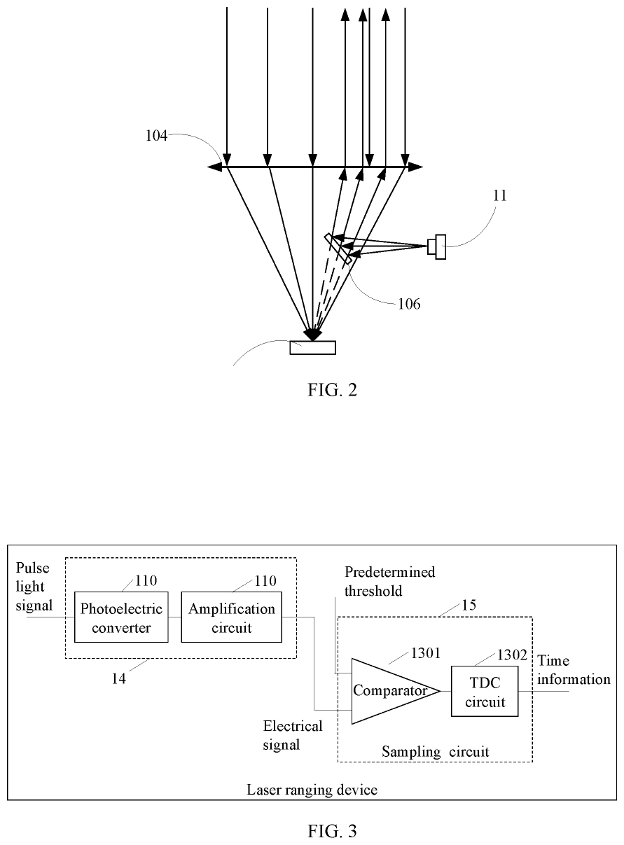

The collimating lens 12 and the converging lens 13 may be two individual convex lenses, or a same lens, for example, a same convex lens. For example, as shown in FIG. 2, the laser-ranging device further includes an optical path change element 106, which is located on a side of the optical assembly 104 close to the emitter 11. The optical path change element 106 may be configured to combine an emitting optical path of the emitter 11 and a receiving optical path of a detecter 105.

The optical path change element 106 may be configured to change an optical path of the light emitted by the emitter 11. The detecter 105 is arranged at a focal plane of the optical assembly 104. The emitter 11 is arranged on a side of the optical axis of the optical assembly 104. The emitter 11 is located at a side relative to the optical assembly 104. The light emitted by the emitter 11 may be projected to the optical path change element 106. The optical path change element 106 may project the light emitted by the emitter 11 to the optical assembly 104. In some embodiments, the optical path change element 106 is arranged away from the optical axis of the optical assembly 104. As such, the blocking of the optical path change element 106 to the optical path of the reflected light may be reduced as much as possible. In some embodiments, the optical path change element 106 is arranged on a side of the optical axis of the optical assembly 104 closer to the emitter 11. In some other embodiments, the optical path change element 106 may be located on a side of the optical axis of the optical assembly 104 away from the emitter 11.

In some embodiments, the optical path change element 106 may reflect the light emitted by the emitter 11. In some embodiments shown in FIG. 2, the optical path change element 106 may include a reflector. In some embodiments, a central axis the emitter 11 may be perpendicular to a central axis of the detecter 105. A reflection surface of the optical path change element 106 is arranged 45° to the central axis of the emitter 11 and 45° to the central axis of the detecter 105. The above describes only an example, the present disclosure is not limited to the example. In some other embodiments, the emitter 11, the detecter 105, and the optical path change element 106 may be arranged at other angles.

A distance from the emitter 11 to the optical path change element 106 may be equal to a distance from the detecter 105 to the optical path change element 106. Because the detecter 105 is arranged on the focal plane of the optical assembly 104, the distance from the emitter 11 to the optical path change element 106 may be substantially equal to a distance from the optical path change element 106 to the focal point of the optical assembly 104. The light emitted from the emitter 11 may be equivalent to light emitted from the focal point. The optical assembly 104 may have a good collimation effect on the light.

As shown in FIG. 2, the laser-ranging device further includes the detecter 105. The detecter 105 may be configured to receive the converged light converged by the converging lens and convert the converged light into an electrical signal. The detecter 105 may be further configured to determine the distance between the to-be-detected object and the laser-ranging device according to the electrical signal. The detecter 105 may include any structure that can realize the above function.

For example, as shown in FIG. 1, the detecter 105 includes a receiver 14, a sampling circuit 15, and a controller 140. The emitter 11 may emit the laser pulse sequence. The receiver 14 may be configured to receive the laser pulse sequence reflected by the to-be-detected object, perform photoelectric conversion on the laser pulse sequence to obtain an electrical signal, and process the electrical signal to output to the sampling circuit 15. The sampling circuit 15 may be configured to perform sampling on the electrical signal to measure a time difference between the transmission and reception of the laser pulse sequence. The controller 140 may include a computation circuit. the computation circuit may be configured to determine the distance between the laser-ranging device 100 and the to-be-detected object based on a sampling result of the sampling circuit.

In some embodiments, as shown in FIG. 3, the receiver 14 includes a photoelectric converter 110. The photoelectric converter 110 may be configured to convert the detected laser pulse sequence into the electrical signal. In some embodiments, the photoelectric converter 110 may include a PIN diode or an avalanche photodiode.

In some embodiments, the receiver 14 may include a signal processing circuit. The signal processing circuit may realize amplification and/or filtering of the electrical signal.

In some embodiments, the signal processing circuit includes an amplification circuit 120. The amplification circuit 120 may be configured to amplify the electric signal, e.g., amplify for at least one stage. Amplification stages may be determined according to a device of the sampling circuit.

In some embodiments, the signal processing circuit may include a first stage amplification circuit and a second stage amplification circuit. The first stage amplification circuit may be configured to perform amplification on the electrical signal output by the photoelectric converter 110. The second stage amplification circuit may be configured to perform further amplification on the electrical signal from the first stage amplification circuit.

For example, the first stage amplification circuit may include a transimpedance amplifier. The second stage amplification circuit may include another type of signal amplifier.

In some embodiments, when the device of the sampling circuit includes an analog-to-digital converter (ADC), the electrical signal may be amplified by using a one-stage amplification circuit or an amplification circuit having at least two stages.

In some other embodiments, as shown in FIG. 3, the sampling circuit 15 includes a signal comparator 1301 (e.g., an analog comparator (COMP) configured to convert the electrical signal into a digital signal) and a time measurement circuit 1302. The electrical signal output by the receiver 14 may enter the time measurement circuit 1302 through the signal comparator 1301. The time measurement circuit 1302 may be configured to measure the time difference between the transmission and reception of the laser pulse sequence.

When the time measurement circuit 1302 includes a time-to-digital converter (TDC), two stages or more than two stages of amplification circuit may be used to perform amplification. The TDC may include a TDC chip, a TDC circuit configured to measure the time based on an internal delay chain of a programmable device, such as a field-programmable gate array (FPGA), or a circuit structure that uses a high-frequency clock to implement time measurement or implements time measurement by counting.

The sampling circuit may be configured to perform sampling on the electrical signal input by the receiver. The sampling circuit may include at least two implementation manners.

In an implementation manner, the sampling circuit may include the signal comparator and the TDC. In some embodiments, after going through the signal comparator, the electrical signal output by the receiver may enter the TDC. Then, the TDC may output an analog signal to the computation circuit.

In another implementation manner, the sampling circuit may include the ADC. In some embodiments, the analog signal input by the receiver to the sampling circuit may be converted into a digital signal by the ADC, and the digital signal may be output to the computation circuit.

In some embodiments, the sampling circuit may be implemented by a programmable device. The programmable device may include an FPGA, an application-specific integrated circuit (ASIC), or a complex programmable logic device (CPLD). The programmable device may include a port. The signal output by the receiver may be input to the device that may be configured to perform sampling through the port, for example, the ADC or the signal comparator.

In some embodiments, if the TDC is the TDC circuit based on the programmable device such as the FPGA, the comparator may be arranged at the FPGA or may not be arranged at the FPGA.

In some embodiments, the signal comparator may be included in the sampling circuit. However, in some other embodiments, the signal comparator may be included in the receiver.

As shown in FIG. 3, a first input terminal (i.e., non-invertion terminal) of the comparator 1301 may be configured to receive the electrical signal input from the amplification circuit 120, that is, the electrical signal after amplification computation. A second input terminal (i.e., invertion terminal) of the comparator 1301 may be configured to receive a predetermined threshold. An output terminal of the comparator 1301 may be configured to output a comparison computation result. The comparison computation result includes time information corresponding to the electrical signal. The predetermined threshold received by the second input terminal of the comparator 1301 may include an electrical signal having a intensity of the predetermined threshold. The comparison computation result may include a digital signal corresponding to the electrical signal after the amplification computation.

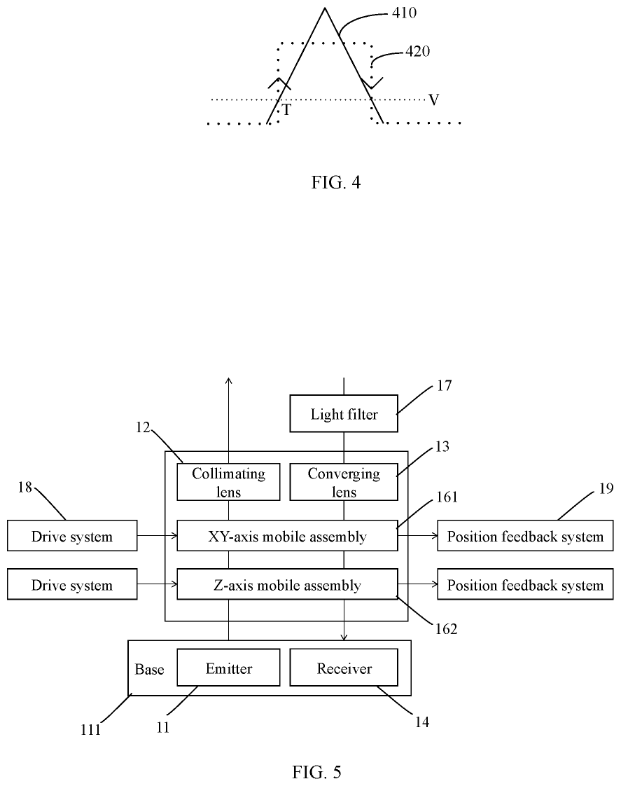

FIG. 4 is a schematic diagram showing a principle of a time extraction method according to some embodiments of the present disclosure. As shown in FIG. 4, the comparison computation is performed on an electrical signal 410 (i.e., an electrical signal 410 input into the comparator) input into the sampling circuit and the predetermined threshold V to obtain a square wave signal 420 as shown by a dotted line. Time T of a jump edge of the square wave signal 420 may be considered as the time when the electrical signal 410 passes through the comparator. When a pulse signal passes through the predetermined threshold from bottom to top, an output of the comparator changes from low to high, and a rising edge of the square wave signal may represent time information of rising edge of the pulse signal at the predetermined threshold. When the pulse signal passes through the threshold of the comparator from the top to the bottom, the output of the comparator changes from high to low, and a falling edge of the square wave signal may represent time information of a downward side of the pulse signal at the threshold. The output signal of the comparator is transmitted to the TDC chip. The TDC chip may be configured to detect time information of edges of the output signal of the comparator. Detected time may use a laser transmission signal as a reference. That is, the time difference dT between the transmission and reception of the laser signal may be detected. Thus, the distance to the to-be-detected object may be calculated by L=c×dT/2, where c denotes the propagation speed of the laser pulse sequence.

In some embodiments, the controller 140 may be further configured to obtain time information, calculate distance information corresponding to the time information, and generate an image according to the distance information, which is not limited by the present disclosure.

In some embodiments, at least two comparators may be provided. Each comparator may include a different predetermined threshold. As such, a same electrical signal may trigger at least one predetermined threshold. The controller may obtain more time information, which helps to improve calculation accuracy.

The laser-ranging device may include a single point ranging device with a small volume. However, the ranging device with a small volume may have limited emitting power, limited detection distance, and a single detection direction, which affects the FOV of the detection of the ranging device and limits its application. Therefore, in the present disclosure, the laser-ranging device is further improved as follows.

As shown in FIG. 5, the laser-ranging device of the present disclosure further includes a drive system 18. The drive system 18 may be configured to drive the optical assembly, which includes the collimating lens 12 and the converging lens 13, to move in the plane perpendicular to the optical axis of the laser pulse sequence and/or along the optical axis direction.

The laser-ranging device may include a coaxial optical path, that is, the light emitted by the laser-ranging device and the light reflected may share at least a portion of the optical path in the laser-ranging device. In some embodiments, the laser-ranging device may include optical paths of different axes. That is, the light emitted by the laser-ranging device and the light reflected may be transmitted along different optical paths in the laser-ranging device. In some embodiments, an example is taken to describe the collimating lens 12 and the converging lens 13 as individual lenses. However, in some other embodiments, the collimating lens 12 and the converging lens of the coaxial optical axis may be the same lens.

In some embodiments, the collimating lens 12 and the converging lens 13 are fixed together and are driven by the same drive system to move simultaneously. As such, the structure is simpler, which reduces the design difficulty of the structure and ensures that the collimating lens 12 and the converging lens 13 move simultaneously. Thus, the optical axis for emitting the light and the optical axis for receiving the reflected light may remain approximately parallel.

In some embodiments, the drive system 18 may be configured to drive the optical assembly including the collimating lens 12 and the converging lens 13 to move in the plane perpendicular to the optical axis of the laser pulse sequence to change the detection direction of the laser-ranging device. The plane perpendicular to the optical axis of the laser pulse sequence may be defined as X and Y directions.

In some embodiments, after a target detection direction is determined, the laser-ranging device may control the collimating lens 12 and the converging lens 13 of the optical assembly to move in the plane perpendicular to the optical axis of the laser pulse sequence according to the target detection direction. That is, the optical assembly may be controlled to move to a predetermined position in the plane perpendicular to the optical axis.

In an allowable range, the collimating lens 12 and the converging lens 13 may move to any position along the X and Y directions. When the collimating lens 12 and the converging lens 13 move along the X and Y directions, an emitting angle of the laser pulse sequence may change correspondingly. The emitting angle may be related to the positions of the collimating lens 12 and the converging lens 13. According to the positions of the collimating lens 12 and the converging lens 13, the controller may obtain the emitting angle to know angle information of the position where the to-be-detected object is located. In connection with distance information and the angle information of the to-be-detected object, 3D information may be presented.

In some other embodiments, the drive system may be configured to drive the optical assembly including the collimating lens 12 and the converging lens 13 to move back and forth along the optical axis of the laser pulse sequence to change the FOV of the laser-ranging device. In some embodiments, the drive system 18 may be configured to drive the optical assembly to move back and forth along the optical axis to change the divergence angle of the laser pulse sequence. The FOV of the laser-ranging device may be determined by the divergence angle.

In the present disclosure, the optical axis direction of the laser pulse sequence may be along Z-axis. That is, a direction parallel to the emission direction of the laser pulse sequence is Z-axis. The collimating lens 12 and the converging lens 13 may move along the Z-axis.

When the collimating lens 12 and the converging lens 13 are at a certain position (e.g., the emitter being located close to the focal plane of the collimating lens 12), the emitted light signal may be substantially parallel light. Thus, the distance to the to-be-detected object far away may be detected. However, when the collimating lens 12 and the converging lens 13 are at a certain position (e.g., outside or inside the focal plane), the emitted light signal may be cone-shaped. That is, the laser may have a certain divergence angle. Thus, the laser-ranging device may detect the distance to a nearby to-be-detected object within a larger angle.

In some embodiments, a target FOV may be determined. A movement distance of the optical assembly may be controlled along the optical axis according to the target FOV.

The controller 140 may be configured to obtain the positions of the collimating lens 12 and the converging lens 13. In some embodiments, the positions of the collimating lens 12 and the converging lens 13 may be detected in another manner. The controller 140 may be configured to determine whether the current emitted laser pulse sequence is substantially parallel light. When the emitted laser is cone-shaped, the controller 140 may obtain a size of the divergence angle. Thus, in connection with the distance information detected above, the controller 140 may obtain the distance of the to-be-detected object and the angle range where the to-be-detected object is located.

In some embodiments, the collimating lens 12 and the converging lens 13 may move back and forth along the axis direction. The controller 104 may obtain the distance information of the to-be-detected object nearby or far away in a short time. In some embodiments, the focal lengths of the collimating lens 12 and the converging lens 13 may be approximately same to facilitate the laser receiving angle and divergence angle to remain the same at various angles when the lenses move.

Approximate direction information of a target object (i.e., to-be-detected object) relative to the current optical axis may be determined by using an image recognition device or another imaging system through image recognition to determine the target detection direction. The image recognition device or the imaging system may be arranged at the laser-ranging device or a device using the laser-ranging device. For example, when the laser-ranging device may be applied at a camera, the imaging system included in the camera may determine the direction information of the target object relative to the imaging system according to the position of the target object in the image to determine the target detection direction.

In some embodiments, the controller 140 of the laser-ranging device may be configured to receive direction information of the target object and control the drive system to drive the optical assembly to move to the predetermined position according to the direction information.

In some other embodiments, another device, which may detect the positions of the collimating lens 12 and the converging lens 13, for example, a displacement sensor, may be configured to detect positions of the collimating lens 12 and the converging lens 13 after the movement and feedback the position information to the controller 140.

In some embodiments, to realize the movement of the optical assembly, the laser-ranging device may further include a mobile assembly. The drive system may drive the mobile assembly to move to drive the optical assembly to move in the plane perpendicular to the optical axis of the laser pulse sequence and/or along the optical axis.

In some embodiments, as shown in FIG. 5, the laser-ranging device further includes a first mobile assembly 161. The first mobile assembly 161 may be an XY-axis mobile assembly. The drive system 18 may drive the first mobile assembly 161 to move to drive the collimating lens 12 and the converging lens 13 to move in the plane perpendicular to the optical axis of the laser pulse sequence to change a pointing direction of the ranging to generate a 3D scanning effect.

In some embodiments, the laser-ranging device further includes a second mobile assembly 162. The drive system 18 may drive the second mobile assembly 162 to move to drive the collimating lens 12 and the converging lens 13 to move back and forth along the optical axis of the laser pulse sequence. The distances of the optical assembly to the emitter and the receiver may change as needed.

The same drive system may be configured to drive the collimating lens 12 and the converging lens 13 to move in XY-axis directions and a Z-axis direction. In some other embodiments, different drive systems may be configured to drive the collimating lens 12 and the converging lens 13 to move in the XY-axis directions and the Z-axis direction, respectively.

In some embodiments, the drive system may include an electromagnetic driver, a voice coil driver, a piezoelectric ceramic driver, or another suitable driver.

In some embodiments, the drive system may include the electromagnetic driver. The electromagnetic driver may include an electromagnet and a magnetic assembly. The electromagnet may be arranged at a base 111 where the emitter 11 is located. In some embodiments, the emitter and the receiver may be arranged at the base 111. The magnetic assembly may be arranged at the mobile assembly where the optical assembly including the collimating lens 12 and the converging lens 13 is located. For example, the magnetic assembly may be arranged at the first mobile assembly 161 and the second mobile assembly 162. An alternating current (AC) may be applied to the electromagnet to cause the mobile assembly to vibrate. The mobile assembly may vibrate to drive the collimating lens 12 and the converging lens 13 to move.

In some embodiments, the magnetic assembly may include a permanent magnet arranged at the mobile assembly or another magnetic material.

In some embodiments, an elastic body (not shown) may be arranged between the mobile assembly and the base. The drive frequency of the electromagnet may be arranged at about the natural frequency of the elastic body to generate resonance to increase the amplitude and reduce energy loss.

In some embodiments, the laser-ranging device further includes a light filter 17. The light filter 17 may be configured to filter the return light before the converging lens 13 to filter at least a part of the light with a non-operating range wavelength. In some embodiments, the bandwidth of the light filter 17 may be same as the bandwidth of the light emitted by the emitter 11. The light filter 17 may filter light outside the bandwidth of the emitted light and may filter out at least a part of the natural light of the return light to reduce the interference of the natural light on the detection.

The filter spectrum of the light filter may drift as the incident angle of the incident light changes. Thus, in some embodiments, the light filter 17 may be arranged on a side of the converging lens 13 facing away from the detecter. As such, the incident angle of the return light without being converged by the converging lens 13 may have a better consistency compared to the return light converged by the converging lens 13. Therefore, the drift of the filter spectrum caused by the change of the incident angle may be reduced.

In some embodiments, the light filter 17 may use a material with a high refractive index. For example, the refractive index of light filter 17 may be greater than or equal to 1.8. The light filter with a high refractive index is less sensitive to the light incident angle. The spectrum shift of the incident light with the incident angle from 0° to about 30° may be less than a certain value (e.g., 12 nm). Using the light filter 17 with a high refractive index may reduce the problem that the spectrum of the light filter 17 drifts due to the large incident angle of a part of the return light, which causes an increase in the proportion of the return light reflected by the light filter 17.

In some embodiments, in a single channel laser-ranging device, and in an operation cycle, the emitter may emit the laser pulse sequence (i.e., the laser pulse sequence of an emitting path), after passing through the receiver, the sampling circuit, and the computation circuit in sequence, the result of the current detection may be finally determined. In practical applications, in an operation cycle, time needed from the emitter emitting the laser pulse sequence until the computation circuit calculating the distance may be t. A value oft may be determined according to the distance between the object detected by the laser pulse and the laser-ranging device. The longer the distance is, the larger t is. When the object is further away from the laser-ranging device, the optical signal reflected by the object is weaker. When the reflected optical signal is weak to a certain degree, the laser-ranging device may not detect the optical signal. Therefore, the distance between the object corresponding to the optical signal that is the weakest optical signal detected by the laser-ranging device and the laser-ranging device may be referred to as the furthest detection distance of the laser-ranging device. To simplify description, hereinafter, t corresponding to the furthest detection distance is referred to as t0. In some embodiments, the operation cycle is longer than t0. In some embodiments, the operation cycle may be at least 5 times longer than t0. In some other embodiments, the operation cycle may be at least 10 times longer than t0. In some other embodiments, the operation cycle may be at least 15 times longer than t0.

The laser-ranging device may be configured to detect the distance of the detected object to the ranging device and the location of the detected object relative to the ranging device. In some embodiments, the detection device may include radar, for example, a laser radar. The detection device may detect the time of the light transmission between the laser-ranging device and the detected object, that is, time-of-flight (TOF) to detect the distance of the detected object to the laser-ranging device.

The laser-ranging device may be configured to sense external environment information, for example, distance information, angle information, reflection strength information, and speed information of an environment target. In some embodiments, the laser-ranging device of embodiments of the present disclosure may be applied to a mobile apparatus. The ranging device may be mounted at the body of the mobile apparatus. The mobile apparatus including the laser-ranging device may perform detection on the external environment. For example, the distance of the detection mobile apparatus and the obstacle may be used for obstacle avoidance and to perform 2D or 3D surveying on the external environment. In some embodiments, the mobile apparatus may include at least one of the UAV, the vehicle, a remote control vehicle, or a robot. When the laser-ranging device is applied to the UAV, the apparatus body may be the body of the UAV. When the laser-ranging device is applied to the vehicle, the apparatus body may be the body of the vehicle. When the ranging device is applied to the remote control vehicle, the apparatus body may be the vehicle body of the remote control vehicle.

For example, the present disclosure further provides a mobile apparatus. The mobile apparatus includes an adjustable focus imaging system and the above laser-ranging device. The structure of the laser-ranging device is described above, which is not repeated here. The imaging system may be configured to determine the direction information of the target object relative to the imaging system according to the position of the target object in the image. The laser-ranging device may be configured to adjust the detection direction of the laser-ranging device according to the direction information and detect the distance information between the target object and the laser-ranging device. The imaging system may be further configured to adjust the focus according to the distance information obtained by the laser-ranging device to form a clear image.

In some embodiments, as shown in FIG. 1 and FIG. 5, the ranging device further includes the controller 140. The controller 140 may be configured to receive the direction information of the target object feedback by the imaging system and control the drive system 18 to drive the optical assembly including the collimating lens 12 and the converging lens 13 to move to the predetermined position according to the direction information.

In some embodiments, as shown in FIG. 5, the ranging device includes a position feedback system 19. The position feedback system 19 may be configured to feedback the position information of the optical assembly after the movement to the controller 140. The controller 140 may determine whether the optical assembly moves to the predetermined position. When the optical assembly moves to the predetermined position, the controller 140 may control the drive system to be off to cause the optical assembly to stop moving. When the optical assembly has not moved to the predetermined position, the drive system may continue to drive the mobile circuit to cause the optical assembly to move until the optical assembly moves to the predetermined position.

Different position feedback systems or a same position feedback system may be used for different moving directions. In some embodiments, the position feedback system 19 may include at least one displacement sensor. A number of the displacement sensor may be set according to actual needs.

In some embodiments, the displacement sensor may include a Hall sensor, a grating sensor, a laser sensor, or another sensor capable of realizing displacement measurement.

The mobile device may include a camera. The laser-ranging device may be used for the focus adjustment of the camera. For example, when the camera is used, the movement may generate left and right shaking to cause the photographed object to be away from the imaging position. The laser-ranging device may be used to obtain the distance and direction information of the photographed object to the laser-ranging device. That is, the distance and direction information between the imaging system of the camera and the photographed object may be obtained. According to the distance and direction information, the camera may perform focus adjustment to capture a clear image.

Based on the structure and the operation principle of the laser-ranging device of embodiments of the present disclosure described above, those skilled in the art should understand that the structure and the operation principle of the mobile device of embodiments of the present disclosure. For the sake of brevity, the structures and the operation principle are not repeated here.

Although exemplary embodiments have been described with reference to the accompanying drawings, described exemplary embodiments are merely exemplary, and are not intended to limit the scope of the present disclosure. Those of ordinary skill in the art may make various changes and modifications to exemplary embodiments without departing from the scope and spirit of the present disclosure. All these changes and modifications are intended to be included within the scope of the invention as claimed in the appended claims.

Those of ordinary skill in the art may be aware that the units and algorithm steps of the examples described in combination with embodiments disclosed herein can be implemented by electronic hardware or a combination of computer software and electronic hardware. Whether these functions are executed by hardware or software depends on the specific application and design constraint conditions of the technical solution. Those skilled in the art may use different methods for each specific application to implement the described functions, but such implementation should not be considered as beyond the scope of the present disclosure.

In several embodiments provided in this application, the disclosed device and method may be implemented in another manner. For example, device embodiments described above are merely illustrative. For example, the division of the units is only a logical function division, and there may be another division in actual implementation, for example, multiple units or components can be combined or integrated into another device, or some features may be omitted or not implemented.

In the specification, a lot of specific details are explained. However, embodiments of the present disclosure may be practiced without these specific details. In some embodiments, well-known methods, structures, and technologies are not shown in detail, so as not to obscure the understanding of this specification.

Similarly, to simplify the present disclosure and help understand one or more of the various aspects of the disclosure, in the description of exemplary embodiments of the present disclosure, the various features of the present disclosure are sometimes grouped together into a single embodiment, figure, or description of these features. However, the method of the present invention should not be explained to reflect the intention that the claimed invention requires more features than features explicitly described in each claim. More precisely, as reflected in the corresponding claims, the point of the invention is that a corresponding technical problem may be solved with features less than all features of a single disclosed embodiment. Therefore, the claims following specific embodiment are thus explicitly incorporated into the specific embodiment, wherein each claim itself may be as an individual embodiment of the present invention.

Those skilled in the art may understand that in addition to mutual exclusion between the features, all features disclosed in this specification (including the accompanying claims, abstract, and drawings) and processes or units of any method or device disclosed in this manner may be grouped by any combinations. Unless otherwise specified, each feature disclosed in this specification (including the accompanying claims, abstract, and drawings) may be replaced by an alternative feature providing the same, equivalent, or similar purpose.

In addition, those skilled in the art may understand that although some embodiments described herein include certain features included in other embodiments, the combination of features of different embodiments means that they are within the scope of the present disclosure and form different embodiments. For example, in the claims, any one of claimed embodiments may be used in any combination.

Component embodiments of the present disclosure may be implemented by hardware, or by software modules running on one or more processors, or by a combination thereof. Those skilled in the art should understand that a microprocessor or a digital signal processor (DSP) may be used in practice to implement some or all of the functions of some modules according to embodiments of the present disclosure. The present disclosure may also be implemented as a device program (for example, a computer program and a computer program product) used to execute part or all of the methods described here. Such a program for realizing the present disclosure may be stored in a computer-readable medium or may have a form of one or more signals. Such signals may be downloaded from Internet websites, or provided on carrier signals, or provided in any other forms.

Embodiments of the present disclosure illustrate the present disclosure rather than limit the present disclosure. Those skilled in the art may design alternative embodiments without departing from the scope of the appended claims. In the claims, any reference signs placed between parentheses should not be constructed as a limitation to the claims. The invention may be implemented by hardware including several different elements and a suitably programmed computer. In the unit claims listing several devices, several of these devices may be embodied in a same hardware item. The terms first, second, and third do not indicate any order. These terms may be interpreted as names.

What is claimed is:

1. A laser-ranging device comprising:
an emitter configured to emit a laser pulse sequence;
an optical assembly including:
a collimating lens located on an emitting light path of the emitter and configured to collimate the laser pulse sequence emitted by the emitter and emit the laser pulse sequence out of the laser-ranging device; and
a converging lens configured to converge at least a part of return light reflected by a to-be-detected object;
a detecter configured to receive light converged by the converging lens and convert the light into an electrical signal and determine a distance between the to-be-detected object and the laser-ranging device according to the electrical signal; and
a drive system configured to drive the optical assembly to move in a plane perpendicular to an optical axis of the laser pulse sequence and/or along an optical axis direction of the optical axis.

2. The laser-ranging device of claim 1, wherein the collimating lens and the converging lens are fixed together and are driven by the drive system to move simultaneously.

3. The laser-ranging device of claim 1,
wherein the collimating lens and the converging lens are a same lens;
the device further comprising:
an optical path change element located on a side of the optical assembly close to the emitter and configured to combine the emitting optical path of the emitter and a reception optical path of the detecter.

4. The laser-ranging device of claim 1, wherein the drive system is configured to drive the optical assembly in the plane perpendicular to the optical axis to change a detection direction of the laser-ranging device.

5. The laser-ranging device of claim 4, wherein:
the drive system is configured to control a movement distance of the optical assembly in the plane perpendicular to the optical axis according to a target detection direction.

6. The laser-ranging device of claim 1, wherein the drive system is configured to drive the optical assembly to move back and forth along the optical axis to change a field of view (FOV) of the laser-ranging device.

7. The laser-ranging device of claim 6, wherein:
the drive system is configured to control a movement distance of the optical assembly along the optical axis direction according to a target FOV.

8. The laser-ranging device of claim 6, wherein:
the drive system drives the optical assembly to move back and forth along the optical axis to change a divergence angle of the laser pulse sequence to change the FOV of the laser-ranging device.

9. The laser-ranging device of claim 1, further comprising:
a mobile assembly;
wherein the drive system is configured to drive the mobile assembly to drive the optical assembly to move in the plane perpendicular to the optical axis and/or along the optical axis.

10. The laser-ranging device of claim 9, wherein:
the drive system is configured to drive the mobile assembly to move to drive the optical assembly to move in the plane perpendicular to the optical axis.

11. The laser-ranging device of claim 9, wherein:
the drive system is configured to drive the mobile assembly to move to drive the optical assembly to move along the optical axis.

12. The laser-ranging device of claim 1, further comprising:
a light filter configured to perform light filtering on the return light before the return light reaches the converging lens, to filter out at least a part of light with a non-operation wavelength.

13. The laser-ranging device of claim 12, wherein the light filter is located on a side of the converging lens facing away from the detecter.

14. The laser-ranging device of claim 1, wherein the drive system includes an electromagnetic driver, a voice coil driver, or a piezoelectric ceramic driver.

15. The laser-ranging device of claim 1, further comprising:
a base carrying the emitter; and
a mobile assembly carrying the optical assembly;
wherein the drive system includes an electromagnetic driver including:
a magnetic assembly arranged at the mobile assembly; and
an electromagnet arranged at the base and configured to be applied with an alternating current to cause the mobile assembly to vibrate.

16. The laser-ranging device of claim 15, wherein the magnetic assembly includes a permanent magnet arranged at the mobile assembly.

17. The laser-ranging device of claim 15, further comprising:
an elastic body arranged between the mobile assembly and the base;
wherein the electromagnet is configured to have a drive frequency approximately equaling a natural frequency of the elastic body.

18. The laser-ranging device of claim 1, further comprising:
a base, the emitter being arranged at the base.

19. The laser-ranging device of claim 1, wherein the detecter includes:
a receiver configured to receive the return light and convert the return light into the electrical signal;
a sampling circuit configured to perform sampling on the electrical signal output by the receiver to measure a time difference between emission of the laser pulse sequence and reception of the return light; and
a computation circuit configured to perform calculation based on the time difference to obtain a ranging result.

20. A mobile apparatus comprising:
a focus adjustable imaging system configured to determine direction information of a target object relative to the imaging system according to a position of the target object in an image captured by the imaging system; and
a laser-ranging device configured to adjust a detection direction of the laser-ranging device according to the direction information and detect a distance between the target object and the laser-ranging device, the laser-ranging device including:
an emitter configured to emit a laser pulse sequence;
an optical assembly including:
a collimating lens located on an emitting light path of the emitter and configured to collimate the laser pulse sequence emitted by the emitter and emit the laser pulse sequence out of the laser-ranging device; and
a converging lens configured to converge at least a part of return light reflected by the target object;
a detecter configured to receive light converged by the converging lens and convert the light into an electrical signal and determine the distance between the target object and the laser-ranging device according to the electrical signal; and
a drive system configured to drive the optical assembly to move in a plane perpendicular to an optical axis of the laser pulse sequence and/or along an optical axis direction;
wherein the imaging system is further configured to perform focus adjustment according to the distance obtained by the laser-ranging device.
